(19) United States
(12) Patent Application Publication
(10) Pub. No.: US 2023/0098018 A1
(43) Pub. Date: Mar. 30, 2023

(54) ONBOARD VEHICLE-POWERED WIRELESS REARVIEW AHD TRANSMISSION APPARATUS

(71) Applicant: FXT TECHNOLOGY CO., LIMITED, SHENZHEN (CN)

(72) Inventor: HONGHUA LYU, SHENZHEN (CN)

(21) Appl. No.: 17/511,595

(22) Filed: Oct. 27, 2021

(30) Foreign Application Priority Data
Sep. 27, 2021 (CN) 202122360242.X

(51) Int. Cl. B60R 1/00; H04N 7/18; H04N 7/01; H04W 76/10

(52) U.S. Cl. CPC B60R 1/00; H04N 7/183; H04N 7/0125; H04W 76/10; H04W 4/80

(57) ABSTRACT

The present invention relates to the field of onboard circuit technologies, and provides an onboard vehicle-powered wireless rearview AHD transmission apparatus. A wireless receive end of a transmission processing apparatus is wirelessly connected to a signal transmit end of an AHD camera, and the transmission processing apparatus receives and processes a rearview image signal to generate an AHD video signal for output. As such, stable signal transmission is implemented without installing inside a vehicle a data cable that runs through the vehicle or modifying the inside of the vehicle, thereby reducing a cost and facilitating installation.

### TECHNICAL FIELD

The present invention relates to the field of onboard circuit technologies, and in particular, to an onboard vehicle-powered wireless rearview AHD transmission apparatus.

### BACKGROUND

An analog high definition (AHD) camera is a camera that uses digital signal output. This camera features a small image loss, high image quality, and a small latency during an image transmission process, and can implement a real-time picture transmission effect in data transmission without coding, compression, and other processing.

Because the AHD camera features real-time transmission, the AHD camera is widely used in connection to a rearview mirror or an electronic display in onboard rearview technologies.

In conventional onboard rearview technologies, an AHD camera mainly uses wired connection. Although the wired connection enables a stable signal, a user needs to install inside a vehicle a data cable that runs through the vehicle when installing the AHD camera, and connect the AHD camera to an electronic rearview mirror, causing a relatively high modification cost and difficulty in installation.

In conclusion, in the conventional onboard rearview technologies, an internal structure of a vehicle needs to be modified, and this leads to technical problems of a high modification cost and difficulty in installation.

### SUMMARY

To overcome the preceding disadvantages in the prior art, the present invention provides an onboard vehicle-powered wireless rearview AHD transmission apparatus, including:

an AHD camera, installed on a vehicle and configured to photograph the rear of the vehicle in real time to obtain and send a rearview image signal;

a transmission processing apparatus, where the transmission processing apparatus has a wireless receive end wirelessly connected to a signal transmit end of the AHD camera, and is configured to receive and process the rearview image signal to generate an AHD video signal for output; and a display, connected to an analog output end of the transmission processing apparatus in a wired mode, and configured to receive the AHD video signal for video display.

Further, the transmission processing apparatus includes a vehicle power supply adapter and a power supply circuit; and

the vehicle power supply adapter is electrically connected to the power supply circuit; and a power supply end of the power supply circuit is electrically connected to a power consumption end of the display to provide an operating voltage to the display.

Specifically, the transmission processing apparatus includes an audio/video codec processor; and

the audio/video codec processor is connected to the wireless receive end of the transmission processing apparatus, and configured to receive the rearview image signal.

Specifically, the transmission processing apparatus further includes a video conversion circuit; and

the video conversion circuit is electrically connected to the audio/video codec processor and converts the AHD video signal into an analog signal.

Specifically, the video conversion circuit is connected to the analog output end of the transmission processing apparatus, and the analog output end of the transmission processing apparatus receives the analog signal for output.

Specifically, the wireless connection is Bluetooth connection.

Specifically, the wireless connection is Wi-Fi connection.

Specifically, the display is a rearview mirror.

Specifically, the display is a display with AHD input.

In addition, the present invention provides a vehicle, including the onboard vehicle-powered wireless rearview AHD transmission apparatus according to any one of the preceding implementations.

Compared with the prior art, the present invention has the following beneficial effects:

The present invention provides an onboard vehicle-powered wireless rearview AHD transmission apparatus, including an AHD camera, a transmission processing apparatus, and a display. The AHD camera is installed on a vehicle and configured to photograph the rear of the vehicle in real time to obtain and send a rearview image signal; a wireless receive end of the transmission processing apparatus is wirelessly connected to a signal transmit end of the AHD camera, and the transmission processing apparatus receives and processes the rearview image signal to generate an AHD video signal for output; and the display is connected to an analog output end of the transmission processing apparatus in a wired mode, and configured to receive the AHD video signal for video display. As such, stable signal transmission is implemented without installing inside a vehicle a data cable that runs through the vehicle or modifying the inside of the vehicle, thereby reducing a cost and facilitating installation.

### BRIEF DESCRIPTION OF DRAWINGS

FIG. 1 is a schematic diagram of a circuit structure of an onboard vehicle-powered wireless rearview AHD transmission apparatus;

FIG. 2 is a schematic diagram of a circuit structure of a transmission apparatus;

FIG. 3 is a schematic diagram of another circuit structure of a transmission apparatus;

FIG. 4 is a schematic diagram of another circuit structure of a transmission apparatus; and

FIG. 5 is a schematic diagram of a circuit structure of a vehicle.

### DESCRIPTION OF EMBODIMENTS

The present invention is further described below with reference to the accompanying drawings and specific implementations. It should be noted that, the embodiments or technical features described below can be randomly combined to form new embodiments, provided that no conflict occurs.

### Embodiment 1

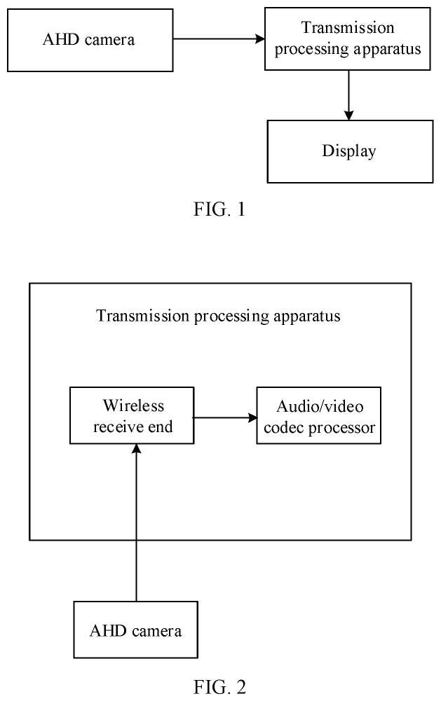

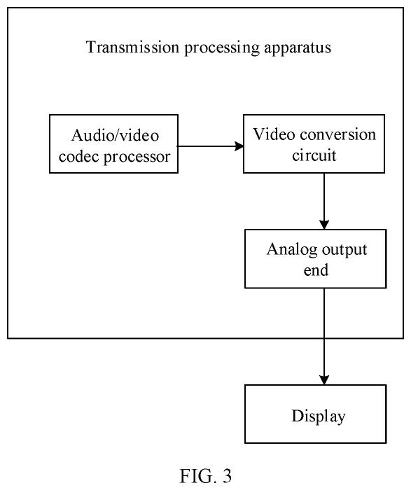

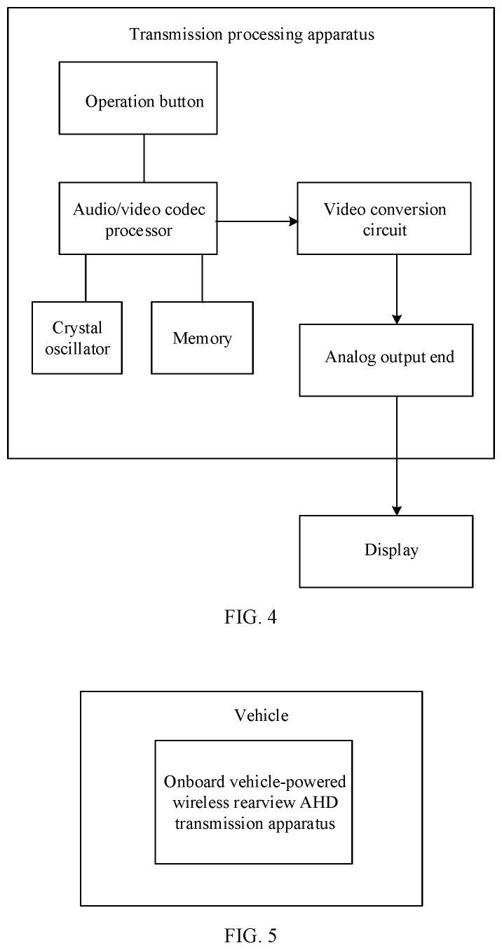

Referring to FIG. 1, this embodiment provides an onboard vehicle-powered wireless rearview AHD transmission apparatus, including:

an AHD camera, installed on a vehicle and configured to photograph the rear of the vehicle in real time to obtain and send a rearview image signal;

a transmission processing apparatus, where the transmission processing apparatus has a wireless receive end wirelessly connected to a signal transmit end of the AHD camera, and is configured to receive and process the rearview image signal to generate an AHD video signal for output; and

a display, connected to an analog output end of the transmission processing apparatus in a wired mode, and configured to receive the AHD video signal for video display.

It should be noted that the AHD camera refers to an analog high definition camera. Its physical resolution may reach 720p or above, and its vertical picture resolution may be 1080i, 720p, or 1080p.

1080i means that the resolution is 1920×1080, and 30 complete pictures are presented every second by interlaced scanning; 720p means that the resolution is 1280×720, and 60 complete pictures are presented every second by progressive scanning; 1080p means that the resolution reaches 1920×1080, and 60 complete pictures are presented every second by sequential scanning.

In addition, AHD is based on an AHD protocol, and uses an analog coaxial cable to transmit progressively-scanned high definition videos.

The AHD technology enables reliable transmission of high definition video signals at an ultra-long distance (500 meters) on an existing analog transmission line. It uses advanced Y/C signal separation and analog filtering technologies, which can effectively reduce a colored noise in a high-frequency region and have better image restoration performance. Compared with that of a conventional AHD product, surveillance image quality of AHD in the present invention has a qualitative leap and improvement, and the highest definition can be equivalent to a full high definition level of network high definition 1080p.

It should be further noted that, the wireless connection may be implemented in various modes, such as Bluetooth connection and Wi-Fi connection.

It should be further noted that, the display may be a rearview mirror or a display with AHD input.

It should be further noted that, the transmission processing apparatus may include different general-purpose modules. A person of ordinary skill in the art knows commonly used modules of the transmission processing apparatus, including functions, interfaces, and internal structures of the modules thereof, and the general-purpose modules are not the innovation of this embodiment. Several examples are given below.

In an example, the transmission processing apparatus includes an audio/video codec processor; and

the audio/video codec processor is connected to the wireless receive end of the transmission processing apparatus, and configured to receive the rearview image signal.

In an example, the transmission processing apparatus further includes a video conversion circuit; and

the video conversion circuit is electrically connected to the audio/video codec processor and converts the AHD video signal into an analog signal. The video conversion circuit may be connected to the analog output end of the transmission processing apparatus, and the analog output end of the transmission processing apparatus receives the analog signal for output.

In an example, the audio/video codec processor may be further connected to regular modules such as a crystal oscillator, a memory, and an operation button, to meet regular requirements.

### Embodiment 2

Based on the preceding embodiment, this embodiment provides the transmission processing apparatus, where the transmission processing apparatus includes a vehicle power supply adapter and a power supply circuit; and the vehicle power supply adapter is electrically connected to the power supply circuit; and a power supply end of the power supply circuit is electrically connected to a power consumption end of the display to provide an operating voltage to the display.

It should be noted that, the vehicle power supply adapter and the power supply circuit are combined to provide an operating voltage to the display, so that the technical effect of local convenient powering can be implemented.

It should be further noted that, the vehicle power supply adapter and the power supply circuit are both regular circuit modules in the art, which are combined and applied in this embodiment to supply power to the local display. Their internal structures and ports are well known to a person of ordinary skill in the art, and are not described in detail herein.

### Embodiment 3

Based on the preceding embodiments, this embodiment provides a vehicle, including the onboard vehicle-powered wireless rearview AHD transmission apparatus according to any one of the preceding implementations.

It should be noted that, this embodiment has the technical solutions and technical effects of the onboard vehicle-powered wireless rearview AHD transmission apparatus in the preceding embodiments, and details are not repeated in this embodiment.

It should be further noted that, the onboard vehicle-powered wireless rearview AHD transmission apparatus in the preceding embodiments includes an AHD camera, a transmission processing apparatus, and a display. The AHD camera is installed on a vehicle and configured to photograph the rear of the vehicle in real time to obtain and send a rearview image signal; a wireless receive end of the transmission processing apparatus is wirelessly connected to a signal transmit end of the AHD camera, and the transmission processing apparatus receives and processes the rearview image signal to generate an AHD video signal for output; and the display is connected to an analog output end of the transmission processing apparatus in a wired mode, and configured to receive the AHD video signal for video display. As such, stable signal transmission is implemented without installing inside a vehicle a data cable that runs through the vehicle or modifying the inside of the vehicle, thereby reducing a cost and facilitating installation.

The preceding implementations are merely preferred implementations of the present invention, and cannot be used to limit the protection scope of the present invention. Any insubstantial changes and replacements made by a person skilled in the art on the basis of the present invention shall fall within the protection scope claimed by the present invention.

What is claimed is:

1. An onboard vehicle-powered wireless rearview AHD transmission apparatus, comprising:
an AHD camera, installed on a vehicle and configured to photograph the rear of the vehicle in real time to obtain and send a rearview image signal;
a transmission processing apparatus, wherein the transmission processing apparatus has a wireless receive end wirelessly connected to a signal transmit end of the AHD camera, and is configured to receive and process the rearview image signal to generate an AHD video signal for output; and
a display, connected to an analog output end of the transmission processing apparatus in a wired mode, and configured to receive the AHD video signal for video display.

2. The onboard vehicle-powered wireless rearview AHD transmission apparatus according to claim 1, wherein the transmission processing apparatus comprises a vehicle power supply adapter and a power supply circuit; and
the vehicle power supply adapter is electrically connected to the power supply circuit; and a power supply end of the power supply circuit is electrically connected to a power consumption end of the display to provide an operating voltage to the display.

3. The onboard vehicle-powered wireless rearview AHD transmission apparatus according to claim 1, wherein the transmission processing apparatus comprises an audio/video codec processor; and
the audio/video codec processor is connected to the wireless receive end of the transmission processing apparatus, and configured to receive the rearview image signal.

4. The onboard vehicle-powered wireless rearview AHD transmission apparatus according to claim 3, wherein the transmission processing apparatus further comprises a video conversion circuit; and
the video conversion circuit is electrically connected to the audio/video codec processor and converts the AHD video signal into an analog signal.

5. The onboard vehicle-powered wireless rearview AHD transmission apparatus according to claim 4, wherein the video conversion circuit is connected to the analog output end of the transmission processing apparatus, and the analog output end of the transmission processing apparatus receives the analog signal for output.

6. The onboard vehicle-powered wireless rearview AHD transmission apparatus according to claim 1, wherein the wireless connection is Bluetooth connection.

7. The onboard vehicle-powered wireless rearview AHD transmission apparatus according to claim 1, wherein the wireless connection is Wi-Fi connection.

8. The onboard vehicle-powered wireless rearview AHD transmission apparatus according to claim 1, wherein the display is a rearview mirror.

9. The onboard vehicle-powered wireless rearview AHD transmission apparatus according to claim 1, wherein the display is a display with AHD input.

10. A vehicle, comprising the onboard vehicle-powered wireless rearview AHD transmission apparatus according to claim 1.
